(19) United States
(12) Patent Application Publication
(10) Pub. No.: US 2013/0014825 A1
(43) Pub. Date: Jan. 17, 2013

(54) METHOD FOR CIRCULATING WATER THROUGH THE INSIDE OF A PIPELINE

(71) Applicant: Sung Yeel Chol, Siheung-si (KR)

(72) Inventor: Sung Yeel Chol, Siheung-si (KR)

(21) Appl. No.: 13/635,456

(22) PCT Filed: Feb. 28, 2011
(86) PCT No.: PCT/KR2011/001409

§ 371 Date: Sep. 17, 2012

(30) Foreign Application Priority Data
Mar. 15, 2010 (KR) 10-2010-0022554

(51) Int. Cl. F16L 53/00

(52) U.S. Cl. 137/1

(57) ABSTRACT

The present invention relates to a method for circulating water through the inside of a pipeline, and to a method for saving water and preventing a water pipe and a meter from being frozen or bursting during the wintertime using the method for circulating water through the inside of a pipeline. The method of the present invention involves enabling a pipe arranged inside a hot water pipe to reach the front of a faucet or a shower valve to form a double passage, and connecting the pipe to a pump such that water circulates through the inside of the hot water pipe of a boiler to keep the temperature of the inside of the hot water pipe at a predetermined temperature level. Thus, cold water is prevented from being supplied during an initial use of hot water or a shower, thereby preventing a waste of tap water.

### TECHNICAL FIELD

The present invention relates to a method for circulating water through the inside of a pipeline, more specifically, a water meter and a hot water pipe of water pipe boiler, in particular, a method for saving the water and preventing burst by freeze in winter by means of circulation through the inside of a water pipe.

### DESCRIPTION OF RELATED ART

In the use of hot water through a boiler, since the length of water pipe is long, when hot water is initially used in a shower or a faucet, an event may occur that user is surprised or embarrassed due to cold water coming out as much as the amount inside the water pipe without intention, and the cold water just flows to be discarded until the hot water comes out.

Furthermore, due to freeze or burst by freeze of the water pipe or water meter in winter, inconvenience is caused in living and also monetary expenditure is caused.

### SUMMARY OF THE PRESENT INVENTION

The present invention has been devised for solving the above-mentioned problems, and its object is to provide a method for saving the water by preventing the cold water from coming out during initial use of the hot water without intention, and a method for preventing the freeze or burst by freeze of the water pipe or water meter in winter.

Furthermore, according to the method for circulating water through the inside of pipeline of the present invention, another object is to provide a method for enabling water circulation even through the inside of a long pipeline to which a certain pressure is applied.

According to the present invention for achieving the objects.

A pipe is inserted inside the pipeline to form a double passage, and the inserted pipe is connected to an outlet port of an circulation pump installed inside the pipeline, and then the pipe inside the pipeline is inserted into a hot water bin and an end of the pipe is connected to an inlet port of the pump, and when a valve is closed and the pump is automatically or manually operated according to external signal value, fluid flows through the pipe inserted inside the pipeline up to an end of the valve and then from there flows back through the pipeline, whereby the water is circulated inside the pipeline.

According to the method of the present invention as described above, since the hot water of a certain temperature comes out during initial use of hot water, the hot water can be immediately used without wasting the water, and thus effects are obtained that water is saved and the water pipe or water meter is prevented from being frozen or being frozen to burst in winter.

### BRIEF DESCRIPTION OF THE DRAWING

FIG. 1 is a view showing flow of fluid inside a pipeline according to the present invention.

FIG. 2 is a front view showing installation structure inside the pipeline according to the present invention.

FIG. 3 is a view showing the structure of a pump installed inside the pipeline according to the present invention.

### MODES FOR CARRYING OUT THE INVENTION

Hereinafter, a preferred example of the present invention will be described with reference to the attached drawings so that present invention can be easily carried out by those having the ordinary skill in the technical field to which the present invention belongs. However, in detailed description of the preferred example of the present invention, if it is determined that detailed description of known relevant functions or constructions may unnecessarily obscure the gist of the present invention, the detailed description thereof will be omitted.

In addition, when it is mentioned that a part is “connected” with another part, it means not only “direct connection” but also “indirect connection” with different elements interposed between the two parts. Furthermore, the expression “comprise” means that it does not exclude another components and may further include the another components unless particularly otherwise mentioned.

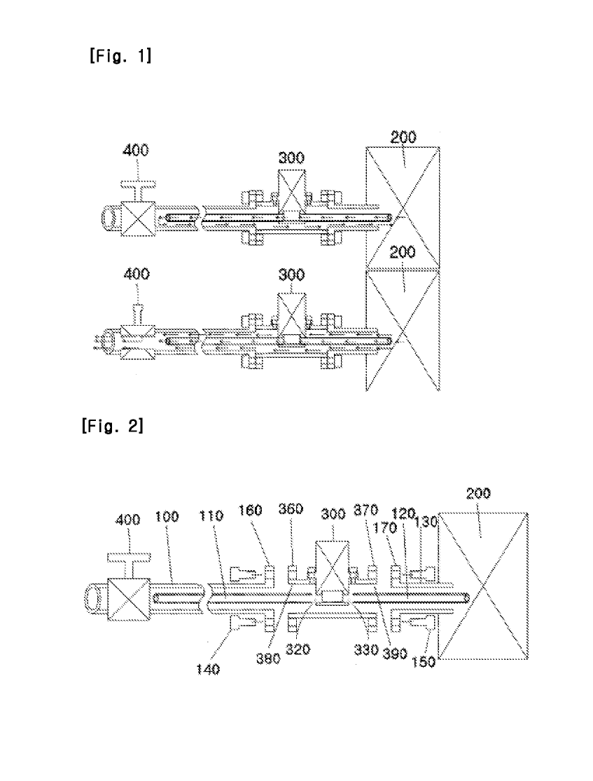

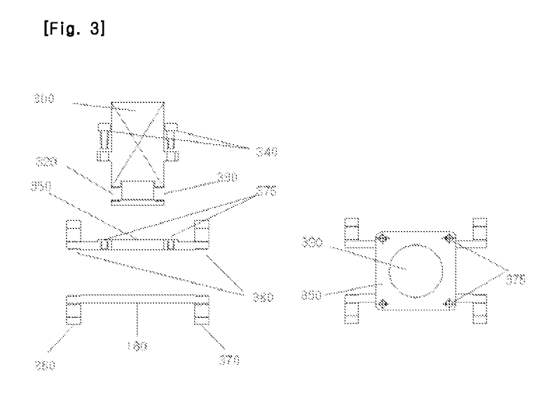

FIG. 1 is a view showing circulation of fluid inside a pipeline (100), pipeline (180) and pipeline (130) when the method for circulating water through the inside of a pipeline (100) according to the present invention is carried out, FIG. 2 is an exploded front view showing installation structure inside the pipeline (100) according to the present invention, and FIG. 3 is an assembly front view and plane view showing an inner circulation pump (300) of the pipeline (180) according to the present invention.

The construction of the present invention comprises the pipeline (100), pipeline (180) and pipeline (130), pipes (110, 120) inserted inside the pipelines, and the inner circulation pump (300) connected with the inserted pipes.

In carrying out the method for circulating water through the inside of the pipeline (100), after the pump (300) is inserted into a hole (390) in a flat surface part (350) of the pipeline (180), the pump is fastened to a body of the pipeline (180) by means of bolts (375). Then, the pipe (110) is inserted through the pipeline (100) up to the front of a valve (400), thereby forming a dual passage, and the inserted pipe (110) is connected to an outlet port (320) of the circulation pump (300) inside the pipeline (180), and a flange (160) connected with the pipeline (100) and a flange (360) connected with the pipeline (180) are fastened by means of bolts (140). Then, the pipe (120) is inserted through the pipeline (130) into a hot water bin (200) of boiler and then connected with an inlet port (330) of the pump (300), and a flange (170) connected with the pipeline (130) and a flange (370) connected with the pipeline (180) are fastened by means of bolts (150).

When the valve (400) is closed and the pump (300) is operated, the pump (300) draws the fluid through the inserted pipe (120). The fluid flows through the pipe (110) arranged inside the pipeline (100) up to the front of the valve (400) and then from there flows back into the hot water bin (200) through the pipeline (180) connected with the pipeline (100) and pipeline (130), whereby the water is circulated.

The above-described present invention may be variously modified or applied by those having the ordinary skill in the technical field to which the present invention belongs, and the scope of technical concept according to the present invention should be defined by the following claims.

What is claimed:

1. A method for circulating water through the inside of a pipeline, wherein a pipe (110) is inserted through a pipeline (100) up to the front of a valve (400), thereby forming a dual passage, and the inserted pipe (110) is connected to an outlet port (320) of a circulation pump (300) inside a pipeline (180), and a flange (160) connected with the pipeline (100) and a flange (360) connected with the pipeline (180) are fastened by means of bolts (140), and a pipe (120) is inserted through a pipeline (130) into a hot water bin (200) of boiler and then connected with an inlet port (330) of the pump (300), and a flange (170) connected with the pipeline (130) and a flange (370) connected with the pipeline (180) are fastened by means of bolts (150), and when the pump (300) is automatically or manually operated by signal value of the boiler, the water is circulated inside the pipeline (130), pipeline (180) and pipeline (100) connected to the hot water bin (200).

2. The method for circulating water through the inside of a pipeline according to claim 1, wherein threads (380) and flanges (360, 370) are formed on both end portions of the pipeline (180), and a flat surface part (350) and a pump insertion hole (390) are formed on upper surface of the pipeline (180), and the pump (300) and pipeline (180) are joined by means of bolts (375), and thus the inlet port (330) and outlet port (320) are positioned inside the pipeline.
